(19) United States
(12) Patent Application Publication
(10) Pub. No.: US 2016/0274235 A1
(43) Pub. Date: Sep. 22, 2016

(54) BURIED OBJECT DETECTION SYSTEM

(71) Applicant: REECE INNOVATION CENTRE LIMITED, Newcastle-Upon-Tyne (GB)

(72) Inventors: James Edward Martin, Whitley Bay (GB); Saeed Kiani, Newcastle Upon Tyne (GB); Reza Tamadoni, Durham (GB); Alexander James Wilkinson, Jesmond (GB); Rebecca Melanie Sills, Whitley Bay (GB); Luke Griffiths, Gateshead (GB); Ralf Ferber, Horsham (GB)

(21) Appl. No.: 15/076,533

(22) Filed: Mar. 21, 2016

Related U.S. Application Data
(60) Provisional application No. 62/135,897, filed on Mar. 20, 2015.

(51) Int. Cl. G01S 15/88; G01S 15/04

(52) U.S. Cl. CPC G01S 15/88; G01S 15/04

(57) ABSTRACT

An acoustic ground coupling device comprises a housing compartment filled with particulate material. The housing compartment further comprises at least one acoustic source for generating an acoustic signal and at least one acoustic sensor that detects, for example, back-scattered acoustic signals from the ground.

### RELATED APPLICATIONS

This Application is related to Patent Application No. GB 1504717.8, filed Mar. 20, 2015, and claims priority benefit of U.S. Patent Application No. 61/135,897, filed Mar. 20, 2015, both of which are incorporated fully herein by reference for all purposes.

### BACKGROUND

There exist a number of non-intrusive methods for detecting buried, near-surface objects. The methods used depend primarily on the application. The construction industries use seismic and electromagnetic mapping to find foreign objects. Metal detectors (using electric field disturbance) are also used to find objects near to the surface, and are used often in military and humanitarian mine clearing.

Military route clearance brings additional challenges of real time data analysis and decision-making as detection is only a short range ahead of a moving vehicle. Clearance rate is a prime factor in determining whether a particular technology/embodiment is suitable for route clearance applications. The technology is focused on detecting explosive devices (EDs) over other types of buried object.

Humanitarian area clearance covers a broad range of situations. Areas to be cleared may be large in 2 dimensions (as compared to a primarily 1-dimensional road) and require repeated surveys as sweeps. Time constraints are less significant in this application, but the terrain to be covered may be more rugged with shrubbery and non-level ground prevalent. The threat profile is also different, focusing more on standard military ordnance, which may be been buried for decades.

The present commercial approaches to buried object detection lack advanced techniques for processing multiple signal paths received via different detectors that can improve the signal to noise ratio of the received acoustic signals, or to provide images of the locations of buried objects. From a technical standpoint, none of the current technologies describe the correct physics relevant to the acoustic observations. Therefore, there remains an urgent need for improved methods and apparatus for detecting buried objects.

### SUMMARY

The present embodiments provide methods, apparatus, and systems for detecting buried objects. The present embodiments provide improved signal to noise ratio, improved scanning rate, source-ground acoustic coupling and packaging and usage considerations; thus enabling more detailed scanning with the ability to work in a wider range of environments, and increased robustness and ease of use and maintenance during operational life.

At least one aspect of the embodiments described herein provides for a method of detecting buried objects comprising the steps of: generating an acoustic signal; measuring back-scattered incident acoustic signals; and applying a migration algorithm to the back-scattered signals. In some embodiments, for example, scattered surface waves can be measured and migrated Rayleigh waves, Love waves, or Sholte waves.

A further aspect provides a method for detecting buried objects comprising the steps of: generating an acoustic signal; and using the signal to measure mechanical impedance of the earth, wherein buried objects cause changes in the measured mechanical impedance. Boundary waves measured to measure mechanical impedance may be Rayleigh waves, Love waves, or Sholte waves.

A further aspect provides a method for detecting buried objects comprising the steps of: generating an acoustic signal so as to cause movement of the ground; and measuring generated acoustic signals, whereby the presence of an object affects ground movement and hence affects the generated acoustic signals. In some embodiments higher or lower ground movement is mapped.

A further aspect provides a buried object detection method comprising the steps of: emitting an acoustic signal; and measuring the emitted signal to determine changes in movement of the earth caused by inclusion of buried objects.

A further aspect provides an acoustic subterranean ordnance detection method comprising the steps of: emitting an acoustic signal; and measuring the emitted signal to determine changes in movement of the earth caused by inclusion of buried objects. Earth movement may be determined, for example, by measuring at least one of displacement, velocity, acceleration, pressure, or pressure gradient.

The present embodiments also provide for apparatus or systems for performing these methods. For example, apparatus may comprise at least one acoustic source and at least one acoustic sensor; and may further comprise components that measure earth movement or boundary waves.

In some aspects and embodiments, a plurality of acoustic sources may be used to generate a plurality of acoustic signals; and a plurality of spatially separated acoustic receivers may be used to receive incident acoustic signals. In some aspects and embodiments, an acoustic source may be co-located with an acoustic receiver. Alternatively or additionally, an acoustic source may be spaced from an acoustic receiver. Acoustic sources and receivers can be connected to signal generation and signal processing units. Acoustic sources or acoustic receivers can be rigidly mounted to a substrate or surface. Alternatively or additionally, acoustic sources or acoustic receivers may be flexibly mounted to a substrate or surface. In some aspects and embodiments, an acoustic source may be the same component as an acoustic sensor.

In some embodiments, methods or apparatus may use irregular spatial sampling of acoustic source positions. In some embodiments, methods or apparatus may use irregular spatial sampling of acoustic detector positions. In some embodiments, methods or apparatus may include a multidimensional array (1D, 2D, 3D) comprising at least one acoustic sensor and at least one acoustic sources in a multidimensional array (1D, 2D, 3D). Each source and receiver may be connected to signal generation and processing units.

In at least one embodiment, at least one acoustic sensor or detector is used. Sensors or detectors can be: piezo-electric transceivers; loudspeakers, subwoofers, laser Doppler vibrometer sensors, ultrasonic Doppler vibrometer sensors, geophones, hydrophones, microphones, or accelerometers. The direction or sensitivity at least one of the sensors may be: omni-directional, single axis, dual axis, triple axis, rotational axes. Two or more sensors with different directional sensitivity may be used.

In at least one embodiment, the acoustic source may generate a multitude of elastic signals that propagate from the source location and are either scattered or reflected from sub-surface interfaces or buried objects, or induce resonances within the buried object. The elastic signals emitted from the acoustic source may include: reflections of the compressional (P) and shear waves (vertically polarised Sv and horizontally polarised Sh); refractions (alternatively known as diving waves) of the compressional (P) and shear waves (vertically polarised Sv and horizontally polarised Sh); and surface waves that propagate along the air/earth interface in the case of Rayleigh waves and Love waves on land, or along the water/earth interface in the case of Scholte waves in marine environments.

Multiple acoustic sources may be provided, and may be activated sequentially, absolutely simultaneously, substantially simultaneously, or nearly simultaneously. Multiple acoustic signals may be generated that contain the property of being orthogonal to each other.

Multiple receivers may be provided in a two-dimensional (2D) arrangement to form a three-dimensional (3D) array. In some aspects and embodiments a Rayleigh wave, a Love wave, or a Scholte wave may be excited at the acoustic source.

The apparatus, method, or system of the present embodiments may further comprise at least one additional detection system, for example a physical or chemical detection system such as a metal detection means, a neutron detection means, or a volatile organic chemical detection means. Combinations of two or more different types of detector(s) may be used to increase reliability of the system or to reduce false positives.

The present embodiments may be suitable for use in one or more of the following applications: military; humanitarian mine clearance; highway construction and maintenance; utility infrastructure mapping; and environmental geophysics.

The present embodiments can also provide for a real-time detection and alert system comprising a method, system, or apparatus.

The present embodiments also provide for a vehicle capable of performing the method as described herein, or fitted with apparatus or a system as described herein. The vehicle may further comprise an automatic braking function linked to detection of a buried object. Accordingly, the present embodiments provide for a vehicle configured for detection of hazardous objects, the vehicle further configured to automatically stop or prevent motion if a hazardous object or a potentially hazardous object is detected. The detection means described herein can provide for on-move, real-time detection, and thus the present embodiments also provide for a vehicle having means for on-move, real-time detection of hazardous objects, the vehicle having means for automatically stopping the vehicle or preventing motion upon detection of a hazardous object or a potentially hazardous object.

In at least one embodiment, the vehicle may be unmanned. Alternatively, the vehicle may be manned. The vehicle may be a mine detector/mine clearance vehicle. The vehicle may be a mine detector/mine clearance vehicle with military or humanitarian utility. The present embodiments also provide for a plurality of vehicles including at least one vehicle as described herein, for example a convoy. In some embodiments, all vehicles in the plurality can be fitted with an automatic breaking system operable collectively if a hazardous object is detected by one or more vehicles in the plurality of vehicles.

Different aspects and embodiments as described herein may be used separately or together. Further particular aspects of the present embodiments are set out in the accompanying independent and dependent claims. Features of the dependent claims may be combined with the features of the independent claims as appropriate, and in combination other than those explicitly set out in the claims.

Other aspects, objectives and advantages of the present invention will appear more clearly on reading the following description of several embodiments thereof, given by way of non-limiting examples and with reference to the appended drawings. The figures are not necessarily to scale for all the elements represented so as to improve the readability thereof. In the remainder of the description, for the sake of simplicity, identical, similar or equivalent elements of the various embodiments bear the same numerical references.

### BRIEF DESCRIPTION OF THE DRAWINGS

The present embodiments are further described, by way of example, with reference to the accompanying drawings.

FIG. 1 shows an embodiment in which a number of transceivers are arranged in a 1D line array.

FIG. 2 shows an embodiment of a layout of the transceiver array attached to a vehicle.

FIG. 3A shows an embodiment in which the paths are taken by acoustic signals transmitted from a station 1 and received at stations 2. FIG. 3B then shows how signals transmitted from station 2 and reflected from the same objects would be received at stations 1, 8 and 16.

FIG. 4A shows how a signal transmitted from a station are diffracted when reflected from a buried object in an example embodiment. This signal is then picked up at multiple receivers. This produces generated signals as shown in the stream plot in FIG. 4B. The migration algorithm of the invention converts this into a single received signal at the correct location, as shown in FIG. 4C.

FIG. 5 shows an embodiment of one alternative arrangement of transmitters and receivers. Receivers indicated by o; transmitters indicated by ⋄.

FIG. 6 depicts an example coupling device for an electromechanical shaker's base plate. Components: 1: water resistant fabric; 2: sand compartment; 3: electromagnetic shaker; 4: base plate.

FIG. 7 is a schematic of an example sensor streamer for any surface type coupling. Components: 1: water resistant fabric; 2: sand compartment; 3: sensor #1; 4: sensor #20; 5: sensor base unit; 6: distance between sensors 100 mm.

FIG. 8 shows a flow chart of an example power spectrum density detector technique for object detection.

FIG. 9 shows centre frequency of the baseband spectrum for each signal, found as shown by examining the maxima for the lowest frequency band. 1: power spectrum on top of a buried object; 2: power spectrum, no buried object.

### DETAILED DESCRIPTION

Example embodiments are described herein in sufficient detail to enable those of ordinary skill in the art to embody and implement the systems and processes. It is important to understand that embodiments can be provided in many alternate forms and should not be construed as limited to the examples set forth herein. Accordingly, although embodiments can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

The present embodiments are not limited to the particular methodology, compounds, materials, manufacturing techniques, uses, and applications described herein, as these may vary. The terminology used herein is used for the purpose of describing particular embodiments only, and is not intended to limit the scope of the present invention. Structures described are to be understood also to refer to functional equivalents of such structures. All conjunctions used are to be understood in the most inclusive sense possible. Thus, the term “or” is inclusive unless modified, for example, by “either.” The singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. It will be further understood that the terms “comprises,” “comprising,” “includes,” or “including,” when used herein, specify the presence of stated features, items, steps, operations, elements, or components, but do not preclude the presence or addition of one or more other features, items, steps, operations, elements, components, or groups thereof. Language that may be construed to express approximation should be so understood unless the context clearly dictates otherwise.

Unless otherwise defined, all terms (including technical and scientific terms) used herein are to be interpreted as is customary in the art. It will be further understood that terms in common usage should also be interpreted as is customary in the relevant art and not in an idealized or overly formal sense unless expressly so defined herein.

All patents and other publications identified are incorporated herein by reference for the purpose of describing and disclosing, for example, the methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason.

The technological landscape of subterranean mine detection is diverse. Technologies can be primarily classified as removal, triggering or observational. Removal technologies clear mines to a ‘safe’ area without any explicit detection. These technologies are primarily mine ploughs, humanitarian rotary combs and suchlike. These technologies are primarily used to clear a safe lane. The ordnance removed is easier to detect once ‘dug-up’ in this fashion, but still requires careful searching by manual methods.

Triggering detection involves activating any buried explosive ordnance from a safe condition. Examples of this technology are mine roller systems and flails that activate pressure mines, or magnetic signal duplicators that activate magnetically fused mines. These systems are controlled from a heavily armoured vehicle at a standoff distance from the suspect area. They can be effective for a known threat type, however they are ineffective against command operated EDs (operated by, for example, wire, radio, or phone command).

Observational technologies involve detecting the mine without activating it. The old and most thorough form of this technique is a man armed with a probe and a trowel. This is still one of the major methods employed for humanitarian de-mining. The clearance rate is very slow, however, and so its use in military route clearance is curtailed.

A relatively new technique employed in military route clearance involves ground penetrating radar. A number of military systems exist based on commercial hardware. These systems are also used in the construction industry. They use microwave-wavelength radar signals emitted into the ground; the reflected signals are then analysed for their time delay (indicating depth), strength (indicating density) and spatial profile (indicating the geometry of the detected object). These systems provide good resolution, however real time data processing is intensive, requiring a large amount of compute power. A key drawback of this technology is that it offers almost nil performance over water impregnated ground conditions, where most of the incident microwave radar signal is absorbed by the liquid water molecules. Ground penetrating radar is only useful in arid desert or frozen permafrost terrains.

Acoustic mine detection offers the possibility of avoiding this drawback as it works as effectively in water impregnated soils as elsewhere. A large body of research exists into this as a technique, which has resulted in one commercial system in the military market.

The university of Mississippi and elsewhere has conducted an extensive amount of public research into the use of acoustic and other mine detection methods. See, e.g., Sabatier, Advances in Acoustic Landmine Detection, Battlefield Acoustic Sensing for ISR Applications 5-1 (Meeting Proc. RTO-MP-SET-107, Paper 5, Neuilly-sur-Seine, France, 2006); Sabatier, Basic Physical Principles & Mine Features Exploited by the Technology, ALTERNATIVES FOR LANDMINE DETECTION 149 (2003). Other research has been carried out around the world at other universities, but practical inventions arising from this research are rare. Such research has focused on the use of Laser Doppler Vibrometry to measure the surface resonance induced by the passing of a Rayleigh-type seismic wave over a buried mine. An available military system using this technique is Raytheon's Soteria Product. See Soteria: Countering Explosive Devices, Raytheon UKnews (Raytheon UK Pub., Summer, 2013). This system has limitations in that the vehicle must remain stationary while an area is observed, and this process can take minutes at a time. This discounts such a system as an effective route clearance tool, particularly in military applications.

Researchers in India have reported using Ultrasonic Doppler Vibrometry (UDV) as a detector rather than a more conventional Laser Doppler Vibrometer (LDV) system; and have also reported a wheel with included exciters that act as an acoustic source. Rajesh et al., Advanced Acousto-ultrasonic Landmine, IEEE Global Humanitarian Tech. Conf. s. 1 (2011). This wheel is not able to act as a receiver, however, and lacks features required to turn it into a workable solution (primarily a contacting layer for ensuring good acoustic coupling between the wheel and the ground).

None of the reported approaches incorporate advanced techniques for processing multiple signal paths received via different detectors in order to improve the signal to noise ratio of the received acoustic signals, or to provide images of the locations of buried objects. Further, none of the current approaches describe the correct physics relevant to the acoustic observations, stating that the acoustic signal propagating from the source excites a resonance at the object that is observed by the sensor. The principal acoustic modes that are useful in imaging buried objects are: reflections, scattering and diffractions of the various incident acoustic signals from the buried object, and changes in mechanical impedance of the earth caused by the inclusion of the buried object.

The present embodiments are advantageous over the current commercially available approaches for detecting buried objects in providing methods, apparatus, systems with improved signal to noise ratio, improved scanning rate, source-ground acoustic coupling and packaging and usage considerations; and enable more detailed scanning with the ability to work in a wider range of environments than current commercial systems, and provide increased robustness and ease of use and maintenance during operational life.

Accordingly, an aspect of the present embodiments provides a method of detecting buried objects, comprising the steps of: generating an acoustic signal; measuring back scattered incident acoustic signals; and applying a migration algorithm to the back scattered signals. In some embodiments, for example, scattered surface waves may be measured and migrated, for example Rayleigh waves, Love waves or Sholte waves.

Another aspect provides a method for detecting buried objects comprising the steps of: generating an acoustic signal; and using the signal to measure mechanical impedance of the earth, buried objects causing changes in the measured mechanical impedance. In some embodiments, for example, boundary waves can be measured to measure mechanical impedance Rayleigh waves, Love waves or Sholte waves. A further aspect provides a method for detecting buried objects comprising the steps of: generating an acoustic signal so as to cause movement of the ground; and measuring generated acoustic signals; whereby the presence of an object affects ground movement and hence affects the generated acoustic signals. In some embodiments, for example, higher or lower ground movement is mapped. A further aspect provides a buried object detection method comprising the steps of: emitting an acoustic signal; and measuring the emitted signal to determine changes in movement of the earth caused by inclusion of buried objects. A further aspect provides an acoustic subterranean ordnance detection method comprising the steps of: emitting an acoustic signal; and measuring the emitted signal to determine changes in movement of the earth caused by inclusion of buried objects. Earth movement may be determined, for example, by measuring displacement, velocity, acceleration, pressure, pressure gradient, or a combination of these measuring steps.

The present embodiments also provide for apparatus or systems for performing these aspects, such as apparatus or systems that detect buried objects. In at least one embodiment, the apparatus or systems include at least one acoustic source and at least one acoustic sensor. In at least one embodiment, the apparatus or system further includes components that measure earth movement. In at least one embodiment, the apparatus or system further includes components that measure boundary waves.

Additionally, in some embodiments, a plurality of acoustic sources may be used to generate a plurality of acoustic signals. For example, a plurality of spatially separated acoustic receivers may be used to receive incident acoustic signals. In some aspects and embodiments, an acoustic source may be co-located with an acoustic receiver. Alternatively or additionally, an acoustic source can be spaced from an acoustic receiver. Acoustic sources and receivers may be connected to signal generation and signal processing units. Acoustic sources or acoustic receivers may be rigidly mounted to a substrate or surface. Alternatively or additionally, acoustic sources or acoustic receivers can be flexibly mounted to a substrate or surface. Further, in some aspects and embodiments, an acoustic source may be the same component as an acoustic sensor.

In at least one embodiment, methods and apparatus may use irregular spatial sampling of acoustic source positions. Methods and apparatus may include a multidimensional array (1D, 2D, or 3D) of one or more acoustic sensors, and one or more acoustic sources in a multidimensional array (1D, 2D, or 3D). For example, the array or each source and receiver may be connected to signal generation and processing units.

In at least one embodiment, one or more acoustic sensors or detectors may be used. Sensors or detectors may be: piezo-electric transceivers; loudspeakers, subwoofers, laser Doppler vibrometer sensors, ultrasonic Doppler vibrometer sensors, geophones, hydrophones, microphones, or accelerometers. The direction or sensitivity of at least one of the sensors may be omni-directional, single axis, dual axis, triple axis, or rotational axes. Two or more sensors with different directional sensitivity may be used.

The acoustic source(s) in a multidimensional array, which may be the same component as the sensor(s) (e.g., a piezo-electric transceiver), can be substantially co-located (e.g., within the same sub-assembly) or at locations offset from one another. These sources and receivers are connected to signal generation and processing units and ultimately to a controlling computer, in a manner known to those skilled in the art. The mounting arrangement for these components can be have a rigid frame, or employ a mechanical mounting arrangement that allows relative motion between the components, for example on different spring arms or axles. The use of a flexible mounting arrangement mandates several inventive steps in the method of collecting and processing data, as described herein. Systems conforming to the basic configurations outlined herein can be constructed for use in both land and marine environments.

In at least one embodiment, the acoustic source may generate a multitude of elastic signals that propagate from the source location and are either scattered or reflected from sub-surface interfaces or buried objects, or induce resonances within the buried object. The elastic signals emitted from the acoustic source may include, for example: reflections of the compressional (P) and shear waves (vertically polarised Sv and horizontally polarised Sh); refractions (alternatively known as diving waves) of the compressional (P) and shear waves (vertically polarised Sv and horizontally polarised Sh); and surface waves that propagate along the air/earth interface in the case of Rayleigh waves and Love waves on land, or along the water/earth interface in the case of Scholte waves in marine environments. Multiple acoustic sources may be provided and may be activated sequentially. Multiple acoustic sources may be provided and may be activated absolutely simultaneously. Multiple acoustic sources may be provided and may be activated substantially simultaneously. Multiple acoustic sources may be provided and activation of sources may be near simultaneous. Multiple acoustic signals may be generated that contain the property of being orthogonal to each other. Multiple receivers may be provided in a two-dimensional arrangement to form a three-dimensional array.

The apparatus, method or system of the present embodiments may comprise at least one additional detection system, such as a physical or chemical detection system(s). For example, an additional detection system may comprise a metal detection means, a neutron detection means, or a volatile organic chemical detection means. Combinations of two or more different types of detector(s) may be used to increase reliability of the system and to reduce false positives.

An example embodiment of the apparatus further includes Human Machine Interface (HMI) components to communicate the detection or lack thereof of a buried object back to a user. In other embodiments, however, this equipment may be handled outside of the system and is not a required part of the system. Further, another embodiment of the system may include an interface to other computer systems to signal the detection of a buried object, for example to apply vehicle brakes or active countermeasures; but this is also not a required part of the system.

The present invention may be suitable for use in one or more of the following applications: military; humanitarian mine clearance; highway construction and maintenance; utility infrastructure mapping; and environmental geophysics.

The present invention also provides a real-time detection and alert system comprising a method or apparatus as described herein.

The present embodiments also provide a vehicle having means for detection of hazardous objects, the vehicle including means for automatically stopping the vehicle or preventing motion if a hazardous object or a potentially hazardous object is detected. The present embodiments also provide a vehicle capable of performing the method as described herein, or fitted with apparatus or a system as described herein. The vehicle may comprise an automatic braking function linked to detection of a buried object. The present embodiments also provide a vehicle having means for detection of hazardous objects, the vehicle including means for automatically stopping the vehicle and/or preventing motion if a hazardous object or a potentially hazardous object is detected. The present embodiments also provide a vehicle having means for on-move, real-time detection of hazardous objects, the vehicle including means for automatically stopping the vehicle and/or preventing motion if a hazardous object or a potentially hazardous object is detected. The vehicle may be unmanned. The vehicle may be manned. The vehicle may be a mine detector/mine clearance vehicle with military or humanitarian utility. The present embodiments also provide a convoy of vehicles including one or more vehicles as described herein. In some embodiments, all vehicles in the convoy may be fitted with an automatic breaking system operable collectively if a hazardous object is detected by one or more vehicles in the convoy.

In some aspects and embodiments, the system may generally consist of a multidimensional array (1D, 2D, 3D) of one or more acoustic sensors. It also consists of one or more acoustic sources in a multidimensional array (1D, 2D, 3D), which may either be the same component as the sensor (e.g., a piezo-electric transceiver), substantially co-located (e.g., within the same sub-assembly), or at locations offset from one another. These sources and receivers are generally connected to signal generation and processing units, and ultimately to a controlling computer, in a manner known to those in the art. The mounting arrangement for these receivers may either be a rigid frame, or a mechanical mounting arrangement that allows relative motion between the components, for example on different spring arms or axles. The use of a flexible mounting arrangement mandates several inventive steps in the method of collecting and processing data, as are laid out below. Systems conforming to the basic configurations outlined above can be constructed for use in both land and marine environments.

In at least one embodiment, the acoustic source generates a multitude of elastic signals that propagate from the source location and are either scattered or reflected from sub-surface interfaces or buried objects, or induce resonances within the buried object. The principal elastic signals emitted from the acoustic source that are of most utility include: reflections of the compressional (P) and shear waves (vertically polarised Sv and horizontally polarised Sh); refractions (alternatively known as diving waves) of the compressional (P) and shear waves (vertically polarised Sv and horizontally polarised Sh); and surface waves that propagate along the air/earth interface in the case of Rayleigh waves and Love waves on land, or along the water/earth interface in the case of Scholte waves in marine environments.

An embodiment of the apparatus includes Human Machine Interface (HMI) components to communicate the detection of a buried object, or lack thereof, back to a user. In other embodiments, however, this equipment may be handled outside of the system and is not a required component of the apparatus or system. Furthermore, another embodiment of the system may include an interface to other computer systems to signal the detection of a buried object, for example to apply vehicle brakes or active countermeasures. This is also not a required component of the apparatus or system.

The sensor or detector used at any given position, according to the present embodiments, may be at least one of a number of types, including, but not limited to: piezo-electric transceivers; loudspeakers (including subwoofers); Laser Doppler Vibrometer (LDV) sensors; Ultrasonic Doppler Vibrometer (UDV) sensors; geophones; hydrophones immersed in a fluid or a gel; microphones; or accelerometers. Each of these devices may have a direction of sensitivity sensor that is, for example, omni-directional, single axis, dual axis, triple axis, or rotational axes. Combinations of different such sensors can be used to measure signals that can be combined to achieve wavefield separation and a better measurement of the desired elastic signal.

The present embodiments also provide a method for activating the apparatus described herein in a specific sequence and recording and processing specific properties of the signals generated. For example, one of the transmitters is fired, emitting a defined or controlled signal. Recordings are then taken at a number of the receiver points over a defined time range. This is called a “shot”, with the resulting data being termed a shot record. These are then processed to isolate each of the various acoustic propagation modes or signals that can be utilised to indicate buried objects within the ground. If additional acoustic sources at different locations are used in the system, then this procedure can be repeated in a defined cyclic pattern. After each cycle, the processed signals from each shot can be combined using a spatio-temporal filtering algorithm. This constructively combines signals that represent the same physical location. Reflected, refracted, scattered or diffracted signals in these data can then compared to profiles of known mine types, or passed through a heuristic algorithm to determine potential threats. These data are then recorded and passed to the HMI components, if present. The signal may also be outputted in other ways, for example, as a simple yes/no binary signal representing a given confidence threshold, or as 1D, 2D or 3D images offering the possibility of more detailed interpretation.

As an optional enhancement to the method described herein, the signal used may be defined in order to contain a number of useful properties. For example, it may be designed to contain a range of signal frequencies in a short signal (for example a three-octave pulse) to allow for analysis of non-linear frequency responses. Acoustic signals may be impulses or swept signals.

Another optional enhancement involves generating multiple signals that contain the property of being orthogonal to each other. Alternatively, firing time dithering between the initiation of each acoustic transmitter can be employed. This allows multiple acoustic transmitters to be fired simultaneously, and the signals emitted by each acoustic transmitter separated according to the transmitter that generated them. This allows each data acquisition cycle to take a fraction of the time otherwise required if single source shot records were recorded, allowing for faster data collection and a wider acoustic surveying geometry to be sampled.

The present embodiments also provide for a method of using the described apparatus and algorithms in sequence as part of a real-time detection and alerting system that can be used to detect buried objects in close proximity to the apparatus.

Another optional enhancement of the apparatus or system comprises multiple receivers in a 2D arrangement, creating a 3D array. This allows measurement of the direction of received signals by comparison of the time delay of received signals with the wave velocity. This information can be added into the spatial algorithm to improve its effectiveness.

An example embodiment described herein involves exciting a Rayleigh wave at the acoustic source that propagates in every radial direction from the source. Measurements of the ground movement are recorded. The Rayleigh wave is a boundary wave that propagates along the air/earth interface. The short wavelength components only penetrate to a shallow depth within the earth. As the wavelength increases, then the depth of the Rayleigh wave's penetration and oscillation within the earth increases. If a measurement is made above a buried object that is captured by the oscillating movement of the surrounding earth, then the presence of the object will affect the signal measured above it on the surface. For instance, if the buried object is less dense than the surrounding soil, then the acceleration of the ground measured above the object is greater than at a nearby location unaffected the presence of the object. Similarly, if the buried object is more dense than the surrounding soil, then the acceleration of the ground measured above the object is less than at a nearby location unaffected the presence of the object. This method is effectively measuring the mechanical impedance of the near surface of the earth. Mapping the higher or lower ground movement (accelerations, velocities, displacements or pressures) can identify buried objects that are either less dense or denser than the surrounding soil respectively. The depth of penetration of the incident Rayleigh wave can be inverted to provide approximate depth information of the identified buried object(s). A similar approach is achieved through the excitement of a horizontally polarised Love wave at the surface. A similar approach is achieved through the excitement of the water/earth interface in a marine environment by a Scholte wave.

Another example embodiment relies on recording scattering and diffraction of the incident Rayleigh wave off the surface of the buried object. The Rayleigh wave is excited at the acoustic source position. It propagates radially from the source position. When it is incident on a buried object, some of the Rayleigh wave is scattered or diffracted off the object's surface. The acoustic detectors record the scattered and diffracted Rayleigh wave energy. A class of algorithms, know in the geophysical surveying industry as migration algorithms, can be applied to these scattered signals to focus the scattered and diffracted energy at the exact location of the scattering points, thus providing the location of the buried object. This approach enables a look-ahead, or more accurately, a look-around option for buried object location. The illumination of the buried object may be improved by using multiple acoustic sources at different azimuthal angles with respect to the buried object's position, or 2D or 3D distributions of acoustic sensors. Indeed, this approach can detect the location of buried objects at any azimuth angle surrounding the source and measurement locations. As the source and detectors move to their next survey locations, the mapping of the positions of the buried objects is reinforced. The velocity of the acoustic signals propagating through the medium can be estimated from the data, and knowledge of this velocity provides accurate location of the buried object. The depth of the buried object can be determined by using knowledge of the depth of penetration of the incident Rayleigh wave. The same approach can be used with Love waves on land and Scholte waves in the marine environment. Similar imaging techniques can be applied to compressional and shear wave acoustic signals that are either reflected or refracted from the surface of the buried object.

Both the mechanical impedance and migration of scattered or diffracted acoustic energy approaches can be used in combination to locate buried object locations and the depths of burial. Both provide subtly different information that can eliminate false positives, for example, where a buried stone is misidentified as a buried mine or IED. Both methods not only provide direct information about a buried object, but can also identify that an object has been buried. For example, when an object is buried, a hole is usually dug in soil that had previously become naturally consolidated. When the object is buried, the hole is back-filled; and the back-filled soil is typically less dense and less consolidated than that of the surrounding media. This unconsolidated soil volume is usually, although not exclusively, in the shape of a column above the buried object. The detection of unconsolidated soil above a buried object can be used to further eliminate false positive object identifications. Both approaches can be applied on riverbed, estuary, lake-bottom, or sea-floor. For example, the marine system excites a Scholte-wave that propagates along the water/earth boundary. The mechanical impedance and migration of scattered energy approaches is applied to the marine data as described above.

The data processing and interpretation approaches described herein can also be used in time-lapse mode. Such time-lapse data highlight changes between surveys. If previous data are available from an earlier survey, then these legacy data are scaled and matched before being subtracted from the currently acquired data. Thus, the signals from buried objects and structures that were present during the legacy survey are subtracted from the new survey data. Objects that have been buried after the legacy data were acquired will thus stand out and be much easier to identify. This approach largely eliminates false positive object identification, which is of particular interest to military applications.

An alternative embodiment uses the ambient Rayleigh wave energy that is propagating at the air/earth interface as the acoustic source. This ambient Rayleigh wave energy is generated by vehicles, industrial plant(s), wind coupling into the ground through tree roots, and many other sources that couple their energy into the earth. An example embodiment provides a spatial interferometer sensor by locating a pair of detectors on the ground and cross-correlating the signals recorded on each sensor with that of the other. The interferometric approach effectively generates a trace that is a measure of signal propagating from one sensor to the other. This pair of sensors may replace a single sensor from previous embodiments that included a controlled and active acoustic source. Such spatial interferometric sensors are excellent at measuring surface wave energy propagating in-line with the pair of detectors. Such measurements can be used with both the mechanical impedance and migration of scattered energy approaches to map and characterise buried objects. A related approach for the characterisation of earthquake signals has been reported. See Bensen et al., Processing seismic ambient noise data to obtain reliable broad-bandsurface wave dispersion measurements 169 Geophys. J. Int'l 1239 (2007).

The present embodiments also provide an acoustic ground coupling device comprising a compartment filled with particulate material, the compartment housing a source means for generating an acoustic signal, and a sensor means for detecting back-scattered acoustic signals from the ground. The particulate material may be, for example, a granular material such as sand.

The present embodiments also provide a plurality of compartments as described herein arranged as a streamer.

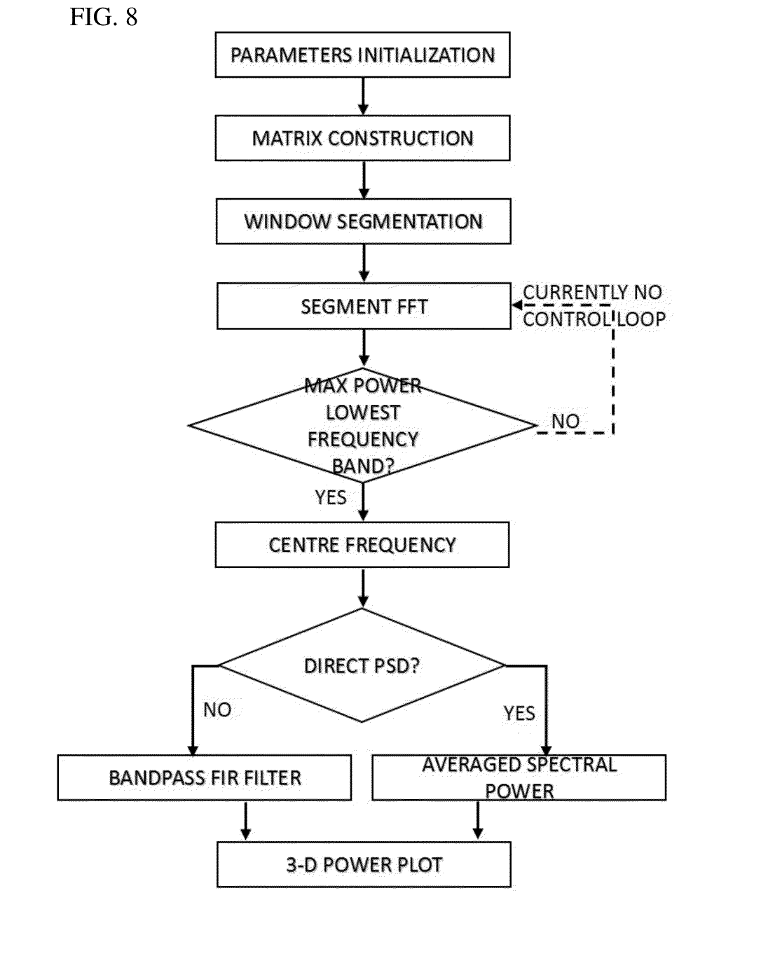

The present embodiments also provide for object detection systems based on power spectrum density. The system may comprise one or more of the steps exemplified in FIG. 8.

The present embodiments also provide a method for detecting buried objects using waveform correlation, comprising the steps of: providing one or more acoustic sensors; determining a reference signal for the or each sensor; emitting a swept frequency acoustic signal; and determining the cross-correlation coefficient between resulting recorded signal and the respective reference signal.

Example embodiments are described herein in sufficient detail to enable those of ordinary skill in the art to embody and implement the systems and processes herein described. It is important to understand that embodiments can be provided in many alternate forms and should not be construed as limited to the examples set forth herein. Accordingly, although embodiments can be modified in various ways and take on various alternative forms, specific embodiments thereof are shown in the drawings and described in detail herein as examples. There is no intent to limit to the particular forms disclosed. On the contrary, all modifications, equivalents, and alternatives falling within the scope of the appended claims should be included. Different aspects and embodiments may be used separately or together. Further particular and preferred aspects of the present invention are set out in the accompanying independent and dependent claims. Features of the dependent claims may be combined with the features of the independent claims as appropriate, and in combination other than those explicitly set out in the claims.

Other aspects, objectives and advantages of the present invention will appear more clearly on reading the following description of several embodiments thereof, given by way of non-limiting examples and with reference to the appended drawings. The figures are not necessarily to scale for all the elements represented so as to improve the readability thereof. Elements of the example embodiments are consistently denoted by the same reference numerals throughout the drawings and detailed description, where appropriate. In the remainder of the description, for the sake of simplicity, identical, similar or equivalent elements of the various embodiments bear the same numerical references.

An example embodiment is shown in FIG. 1. This shows a number of transceivers arranged in a 1D line array. There are 17 transceivers (1) at equal, 0.25 m spacing, giving a total width of 4 m.

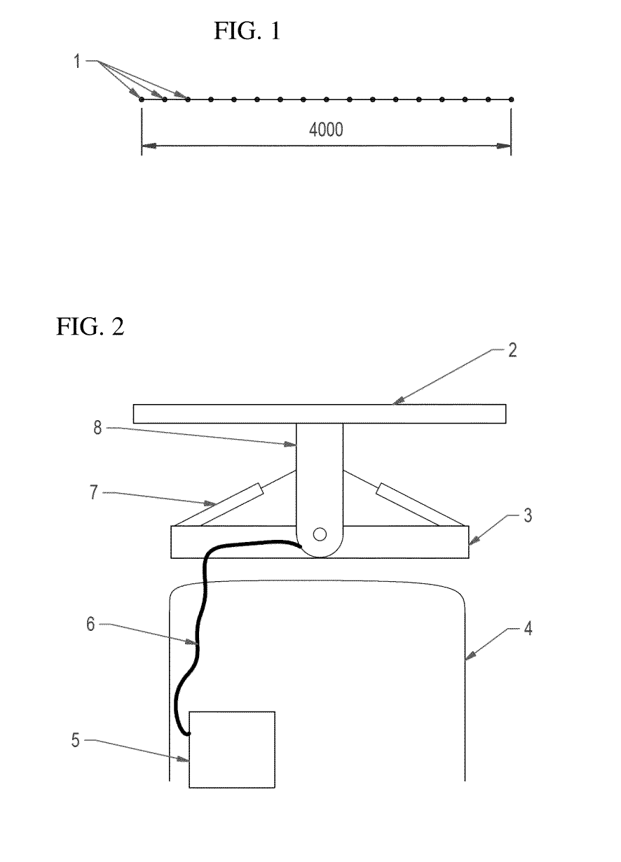

FIG. 2 gives a layout of an example transceiver array attached to a vehicle. The transceivers are mounted on a transverse beam (2). This is in turn attached to a boom (8), which can pivot on a mounting plate (3). The steering arrangement is powered using actuator(s) (7), and allows the sensor array to cover the tracks of the host vehicle during cornering. The mounting plate is attached to the host vehicle (4). Within the vehicle is contained the power and data processing unit (5), connected to the transceiver array by a communications cable (6).

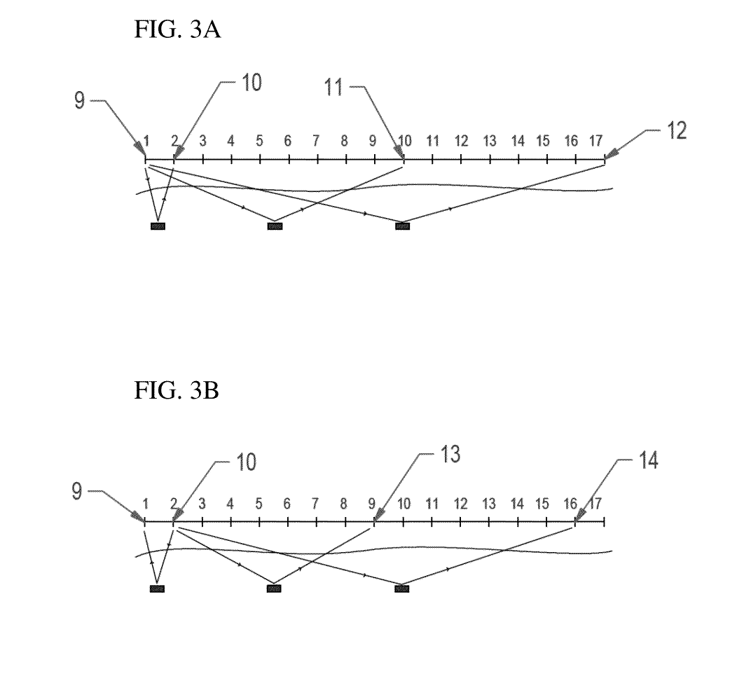

FIG. 3A shows the paths taken by acoustic signals transmitted from station 1 (9) and received at stations 2 (10), 9 (11) and 17 (12). FIG. 3B then shows how signals transmitted from station 2 (10) and reflected from the same objects would be received at stations 1 (9), 8 (13) and 16 (14). The spatial algorithm combines these separate traces from different shots and combines those that represent the same spatial location.

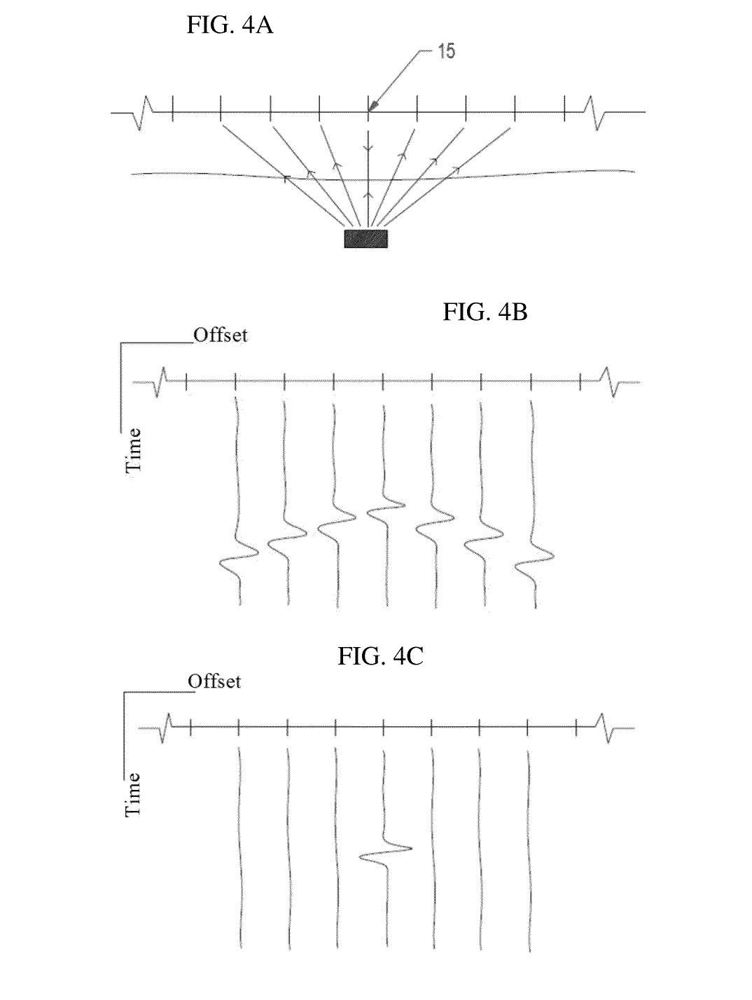

FIG. 4A shows how signals transmitted from a station (15) are diffracted when reflected from a buried object. This signal is then picked up at multiple receivers. This produces generated signals as shown in the stream plot in FIG. 4B. The migration algorithm of the invention converts this into a single received signal at the correct location, as shown in FIG. 4C. These algorithms are processed in the data processing module in FIG. 2. An embodiment of a visualisation technique is to display the strength of the reflected signal as a colour to an operator. Another embodiment is to emit a warning tone should the reflected strength of the received signal be above a set threshold, once the effect of the ground and other known objects is removed.

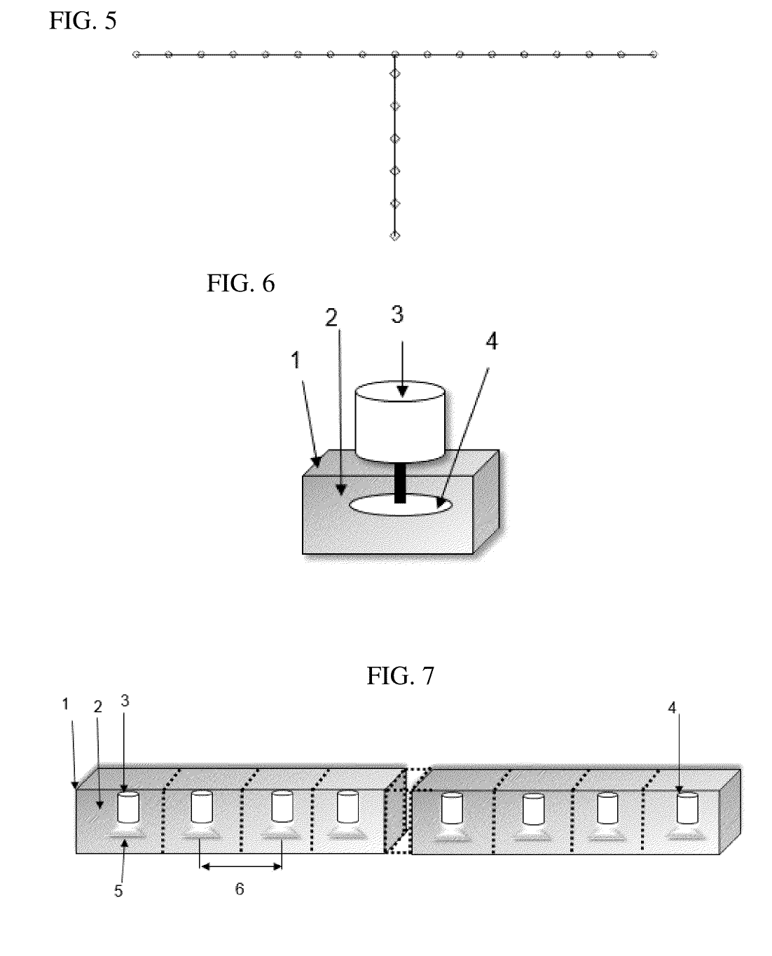

FIG. 5 shows one alternative arrangement of transmitters (17) and receivers (16). In this embodiment, the transmitters (17) are mounted on the boom (8) of FIG. 2. This arrangement provides an alternative area of coverage based around a triangle formed by the outer point. This arrangement could be potentially advantageous for certain applications.

The embodiment(s) described herein are suitable for providing land mine or improvised explosive device (IED) threat-detection in front of a moving vehicle. This provides self-protection for the vehicle, assuming it is moving at a speed that allows it to stop before activating any detected threat. The embodiments are also suitable in a route-proving role to establish there are no detected threats along a given lane driven by the host vehicle at a certain time.

A marine version of the equipment, exploiting exactly the same data acquisition distribution geometries described herein, can be applied to sea-floor, estuary, lake-bottom, or riverbed marine applications.

The present embodiments aid in detection and classification of buried objects in the ground. Advantageously, this capability can be used within the military arena to detect mines and improvised explosive devices (IEDs) lain by an enemy, so that these objects can be detected as a threat, classified as to the type of threat, and defeated before activation.

In humanitarian mine clearance, the present embodiments provide technology that can help detect buried anti-tank and anti-personnel munitions, so that such munitions can be made safe and removed to allow safe civilian activity in the area.

In highway construction and maintenance, the present embodiments allow analysis of a proposed highway route to determine the density of foreign objects buried along the proposed path, and so provide a more informed construction plan.

Additionally, the embodiments described herein can detect and map underground tunnels. The present embodiments can also be used to map utility infrastructure. Many locations have water, sewer, electricity and gas distribution systems that are poorly and inaccurately mapped, d, leading to major issues in effecting repairs and upgrades. Surveying these areas with the acoustic buried object detection approach described herein allows for accurate mapping of each utility network system, and hence enables more efficient completion of intervention and repair.

The present embodiments also provide a useful tool for environmental applications. Environmental geophysical techniques are often used to locate sub-surface structures, locate buried objects that are sources of pollution and to identify mine shafts. The acoustic buried object approach described herein provides an efficient approach by using acoustic methods to provide environmental geophysical services. The environmental applications can be extended to mapping subsidence risks, water table movement, and old mine workings.

The present embodiments also provide technology that can be applied to archaeology surveys to locate and map buried structures or features.

### Ground Coupling Development:

The present embodiments include a practical means of coupling both the source and sensors to the ground surface such that it allows stable and even contact points for the source and sensors without excessively altering the mechanical impedance of the transfer medium. Inappropriate ground coupling can hamper the transmission of acoustic waves, or act as a filtering process such that the frequency spectra of the recorded signals are not a true representation of the propagated acoustic waves through the medium.

The intermediary coupling solution between the source/sensor and the ground surface should have a similar elastic property as the ground underneath the source/sensor where it allows the acoustic waves (useful frequency band) to propagate and reach the sensors. For this purpose, a ground coupling device is constructed as follows:

A metallic shaker base plate is not suitable for coupling to hard surfaces such as gravel. Therefore, a coupling device is constructed as shown in FIG. 6, where it surrounds the base plate of the electromagnetic shaker and provides a deformed coupling to any hard surface such as gravel. The coupling technique shown in FIG. 6 is comprised of a water resistant fabric that is made into a pseudo-cubic enclosure that is filled with fine-grain sand and encloses the electromagnetic base plate.

This ground coupling device or enclosure can easily deform to any surface condition, soft or hard such as soil or gravel. It also allows the shaker to move freely, which is advantageous because the shaker's main body (magnet) needs to be free from any obstruction.

The sensors, e.g., accelerometers', base plates are typically either plastic or metallic, and are not suitable for coupling to hard surfaces such as gravel. A streamer device was constructed to address the sensor-ground coupling problem. The example streamer (FIG. 7) is constructed using a water resistant fabric that is made into twenty pseudo-cubic compartments. Each compartment is filled with fine grain sand and encloses a sensor's base plate. The sensors are secured by the top end of each compartment such that the distance between two adjacent sensors remains at about 100 mm. Therefore using the streamer comprising twenty compartments allows for investigation of two meters of ground at a time.

Object Detection based on Power Spectrum Density (PSD):

A flow chart for an embodiment of this detection methodology is shown in FIG. 8. A swept frequency signal of 50 Hertz to 1000 Hertz can be played using the electromagnetic shaker as exemplified in FIG. 6. The example streamer apparatus, shown in FIG. 7, with an offset of 500 mm from the shaker FIG. 6, records the propagated mechanical waves. The streamer apparatus covers 2 m of ground at a time, and the shaker-streamer system is positioned with 500 mm intervals as far as ground investigation is required.

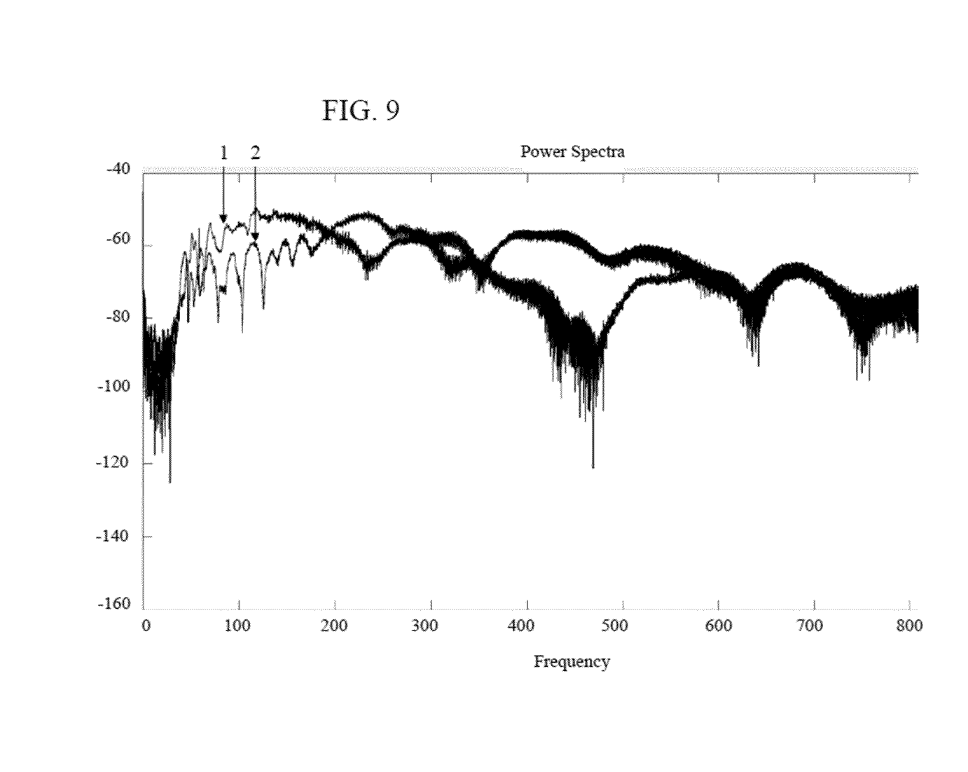

The method of Welch power spectrum (Sabatier, 2006; Welch, 15 IEEE Transact. Audio Electroacoustics 70 (1967)) is employed to transform the signals from the time domain into frequency domain. The centre frequency of the baseband spectrum for each signal is found as shown in FIG. 9 by examining the maxima for the lowest frequency band. This is computed analytically where the frequency power maxima (peaks) of the entire spectrum are compared against their frequency band. The maximum power at the lowest frequency band (baseband) is selected. The centre frequency is then used as a parameter to indicate the centre of the bandwidth of interest. A narrow bandpass filter centred at the computed centre frequency is used to filter the signals for all sensors.

The energies of the filtered signals are computed using the root mean square RMS technique. The energies of the bandpass spectra for all signals are turned into color-map schema where the buried objects are highlighted with higher contrast compared to their surrounding regions.

### Waveform Correlation

A swept frequency signal of 50 Hertz to 1000 Hertz is played using the electromagnetic shaker shown in FIG. 6.

The streamer apparatus, shown in FIG. 7, with an offset of 500 mm from the shaker FIG. 6, records the propagated mechanical waves. The streamer apparatus covers 2 m of ground at a time, and the shaker-streamer system is positioned with 500 mm intervals as far as ground investigation is required.

Over a homogeneous medium, all waveforms for a given receiver should be very similar. The method of waveform correlation exploits the lack of homogeneity in the regions of a medium under investigation as a cursor to a disturbed region or a buried object. The median trace for all the recorded signals of a single sensor is selected. This is referred to as the reference signal.

For each sensor, the cross-correlation coefficient between the recorded signal and the reference signal is computed. The higher the cross-correlation coefficient (between 0 and 1), the better similarity between the reference and the signal. A value closer to zero indicates anomalous behaviour of the actual waveform. The computed coefficients for all traces are then mapped against the sensors' locations using a color-map schema where the disturbed regions, e.g., buried objects, has different color to their surrounding regions

Although illustrative embodiments and aspects have been disclosed in detail herein, with reference to the accompanying drawings, it is understood that the invention is not limited to the precise embodiments shown and that various changes and modifications can be effected therein by one skilled in the art without departing from the scope of the invention as defined by the appended claims and their equivalents.

We claim:

1. An acoustic ground coupling device comprising a compartment housing filled with particulate material, the compartment housing comprising at least one acoustic source that generates an acoustic signal, and at least one acoustic sensor.

2. The device of claim 1, wherein each acoustic source and each acoustic sensor is connected to signal generation and signal processing units.

3. The device of claim 1, comprising a multidimensional array of at least one acoustic source and a multidimensional array of at least one acoustic source.

4. The device of claim 1, wherein an acoustic source is the same component as an acoustic sensor.

5. The device of claim 4, wherein the acoustic source/acoustic sensor is selected from piezo-electric transceivers, loudspeakers, subwoofers, laser Doppler vibrometer sensors, ultrasonic Doppler vibrometer sensors, geophones, hydrophones, microphones, or accelerometers.

6. The device of claim 1, wherein the directional sensitivity of at least one of said acoustic sensors is omni-directional, single axis, dual axis, triple axis, or rotational axes.

7. The method or apparatus as claimed in claim 6, comprising at least two acoustic sensors, each having a different directional sensitivity.

8. The device of claim 1, wherein the acoustic source generates a multitude of elastic signals that propagate from the source location and are either induce resonances within buried objects, or are scattered, back-scattered, or reflected from sub-surface interfaces or buried objects.

9. The device of claim 8, wherein the elastic signals emitted from the acoustic source are selected from: reflections of compressional and shear waves; refractions of compressional and shear waves; surface waves that propagate along the air/earth interface; or surface waves that propagate along the water/earth interface.

10. The device of claim 1, wherein multiple acoustic sources are configured for sequential activation.

11. The device of claim 1, wherein the acoustic source generates multiple acoustic signals that are orthogonal to each other.

12. The device of claim 1, further comprising at least one further detection system selected from a physical detection system, a chemical detection system, a system that measures earth movement, a system that measures boundary waves.

13. The device of claim 12, wherein earth movement is determined by measuring at least one of displacement, velocity, acceleration, pressure, or pressure gradient.

14. A vehicle comprising the device of claim 1.

15. A method of detecting buried objects using the device of claim 12, comprising the steps of:
generating an acoustic signal; and
sensing an acoustic signal;
measuring boundary waves to measure mechanical impedance of the earth;
wherein buried objects cause changes in the measured mechanical impedance.

16. The method of claim 15, wherein the boundary waves are Rayleigh waves, Love waves or Sholte waves.

17. A method of detecting buried objects using the device of claim 1, comprising the steps of:
generating an acoustic signal;
measuring back-scattered incident acoustic signals; and
applying a migration algorithm to the back scattered signals.

18. A method for detecting buried objects using waveform correlation, comprising the steps of:
providing at least one acoustic sensor;
determining a reference signal for each sensor;
emitting a swept frequency acoustic signal; and
determining the cross-correlation coefficient between resulting recorded signal and the respective reference signal.

19. A method for detecting buried objects comprising the steps of:
generating an acoustic signal so as to cause movement of the ground; and
measuring generated acoustic signals, wherein the presence of an object affects ground movement and hence affects the generated acoustic signals.

20. The method of claim 19, wherein ground movement is determined by measuring at least one of displacement, velocity, acceleration, pressure, pressure gradient, boundary waves.
